(19) United States
(12) Patent Application Publication
(10) Pub. No.: US 2019/0243494 A1
(43) Pub. Date: Aug. 8, 2019

(54) TOUCH CONTROL DISPLAY PANEL AND DISPLAY DEVICE THEREOF

(71) Applicant: EverDisplay Optronics (Shanghai) Limited, Shanghai (CN)

(72) Inventors: Pingping ZHANG, Shanghai (CN); Junjun CHEN, Shanghai (CN); HsinChih LIN, Shanghai (CN); Shuangshuang DING, Shanghai (CN)

(73) Assignee: EverDisplay Optronics (Shanghai) Limited, Shanghai (CN)

(21) Appl. No.: 16/184,967

(22) Filed: Nov. 8, 2018

(30) Foreign Application Priority Data
Sep. 8, 2017 (CN) 201710807344.7

(51) Int. Cl. G06F 3/041

(52) U.S. Cl. CPC G06F 3/0412; G06F 2203/04107

(57) ABSTRACT

A touch control display panel includes a substrate and a touch control panel disposed on a first side of the substrate. The touch panel includes a touch control area and a non-touch control area surrounding the touch control area. The non-touch control area includes a plurality of traces and a first shielding layer is disposed on a surface, away from the substrate, of the non-touch control area to shield the traces of the non-touch control area.

### CROSS REFERENCE

This application is based upon and claims the benefit of priority of Chinese Patent Applications No. 201710807344.7, filed on Sep. 8, 2017, the entire contents thereof are incorporated herein by reference.

### TECHNICAL FIELD

The present disclosure relates to the field of touch control display technology, specifically to a touch control display panel and a display device.

### BACKGROUND

With developments of the touch control display technology, the display panel including the function of touch control is widely implemented on lots of applications. 1 shows a prior art of a schematic view of the structure of a touch control panel. As shown in FIG. 1, the touch control display panel includes touch control panel 20 and a glass cover 40 disposed above the touch control panel 20. A plurality of metal traces 21 is deployed on the bezel of the touch control panel. A side surface, facing to the touch control panel 20, is applied an ink layer 30. The ink layer 30 is pasted with the metal traces 21 by an optical transparent adhesive 50. In order to prevent the metal traces 21 to be viewed by the users operating the touch control display panel, in the present technology, the size of the ink layer 30 is greater than the deployment area of the metal traces 21 to fully shield the metal traces 21. Since the position of the cover glass 40 is necessary to be aligned to the position of the touch panel 20 for ensuring that the ink layer 30 completely shields the metal traces 21, the size of the ink layer 30 is greater than the deployment area of the metal traces 21.

However, with the appearance of narrow bezel displays, the market demand for high screen ratio of the display is increased. The bezel of the present liquid crystal display panel or the organic light-emitting display panel within 0.8 mm. However, the bezel of the touch control display panel is about 1.3 mm, since the touch control display panel includes an oversized ink layer 30. Therefore, the size, 1.3 mm, of the bezel has become an obstacle of achieving the goal of the narrow bezel.

### SUMMARY

In one embodiment of the present disclosure, a touch control display panel includes a substrate and a touch control panel disposed on a first side of the substrate. The touch panel includes a touch control area and a non-touch control area surrounding the touch control area. The non-touch control area includes a plurality of traces and a first shielding layer is disposed on a surface, away from the substrate, of the non-touch control area to shield the traces of the non-touch control area.

In one embodiment of the present disclosure, a display device includes a touch control panel. The touch control panel further includes a substrate and a touch control panel disposed on a first side of the substrate. The touch panel includes a touch control area and a non-touch control area surrounding the touch control area. The non-touch control area includes a plurality of traces and a first shielding layer is disposed on a surface, away from the substrate, of the non-touch control area to shield the traces of the non-touch control area.

### BRIEF DESCRIPTION OF THE DRAWINGS

Embodiments of the present disclosure will now be described, by way of example only, with reference to the accompanying schematic drawings in which corresponding reference symbols indicate corresponding parts, and in which:

FIG. 1 shows a prior art of a schematic view of the structure of a touch control panel;

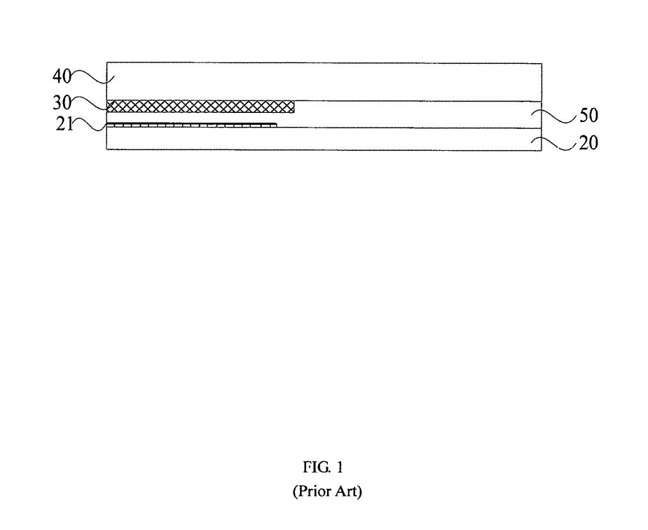

FIG. 2 shows a schematic top view of the structure of a touch control display panel of one embodiment of the present disclosure;

FIG. 3 shows a cross-sectional view alone the A-A′ line of the structure of the touch control display panel of FIG. 2 of one embodiment of the present disclosure;

FIG. 4 shows a schematic top view of the structure of a touch control display panel of one embodiment of the present disclosure;

FIG. 5 shows a cross-sectional view alone the B-B′ line of the structure of the touch control display panel of FIG. 4 of one embodiment of the present disclosure;

FIG. 6 shows a schematic view of the structure of a touch control display panel of one embodiment of the present disclosure; and

FIG. 7 shows a schematic view of the structure of a display device of one embodiment of the present disclosure.

### DETAILED DESCRIPTION

In the following, embodiments of the present disclosure will be described in detail referring to figures. The concept and its realizations of the present disclosure can be implemented in a plurality of forms, and should not be understood to be limited to the embodiments described hereafter.

The present disclosure provides a touch control display panel including a substrate and a touch control panel disposed on a first side of the substrate. The touch panel includes a touch control area and a non-touch control area surrounding the touch control area. The non-touch control area includes a plurality of traces and a first shielding layer is disposed on a surface, away from the substrate, of the non-touch control area to shield the traces of the non-touch control area.

Therefore, the traces are not viewable when the users are operating the touch control display panel. Since the traces and the first shielding layer are disposed on the same side of the touch control panel, the first shielding layer is completely shielding the traces to reduce the size of the first shielding layer. Moreover, there is no alignment between the first shielding layer and the traces. The size of the non-touch control area of the touch control panel is then reduced for achieving the goal of a narrow bezel design for the touch control display panel.

The mentioned technical features are the core idea of the present disclosure, and the technical features in the embodiments of the present disclosure will be clearly and completely described in the followings.

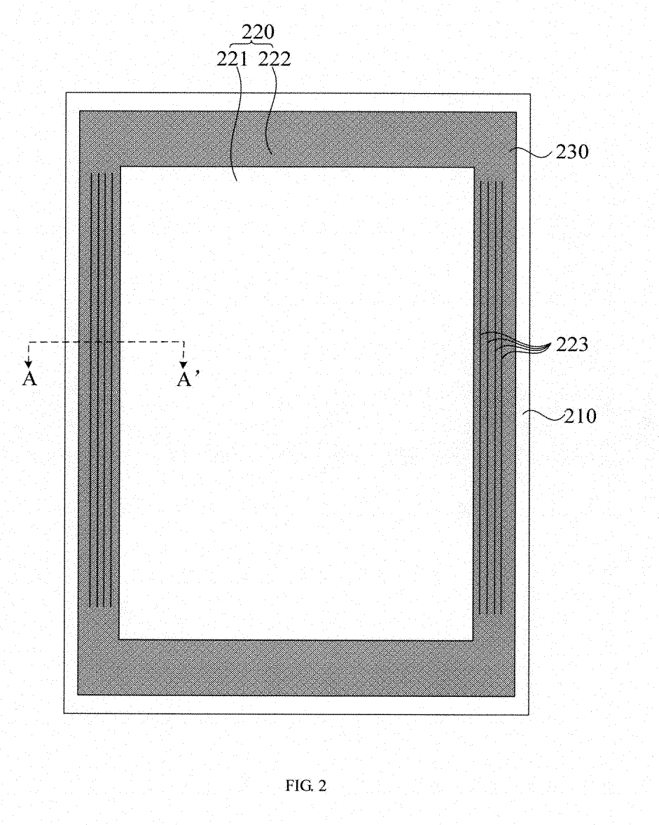

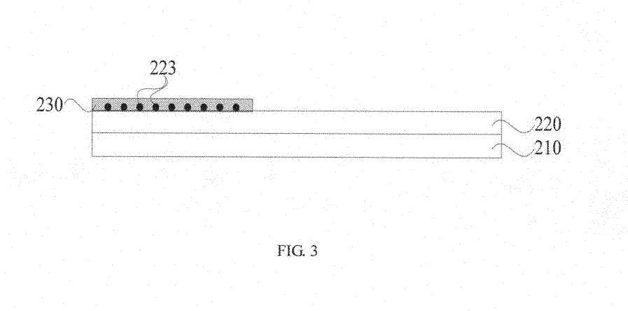

FIG. 2 shows a schematic top view of the structure of a touch control display panel of one embodiment of the present disclosure. FIG. 3 shows a cross-sectional view alone the A-A′ line of the structure of the touch control display panel of FIG. 2 of one embodiment of the present disclosure. As show in FIG. 2 and FIG. 3, the touch control display panel includes a substrate 210 and a touch control panel 220 disposed on a first side of the substrate 210. The touch control panel 220 includes a touch control area 221 and a non-touch control area surrounding the touch control area 221.

For example, the non-touch control area 222 includes a plurality of traces 223 and a first shielding layer 230 is disposed on a surface, away from the substrate 210, of the non-touch control area 222 to shield the traces 223 of the non-touch control area 222. In this embodiment, the touch control panel 220 includes the touch control area 221 and the non-touch control area 222. Moreover, the non-touch control area 222 includes the traces 223, e.g. touch control traces, on the touch control panel 220 in order to gain larger touch control area 221 of the touch control panel 220. Moreover, the first shielding layer 230 is coated on a side, away from the substrate 210, of the non-touch control area 222 in order to shield the traces 223. The traces 223 are then not viewable from the touch control side of the touch control panel 220. As shown in FIGS. 2 and 3, the traces are not viewed by the users when the users are using the touch control display device.

In some embodiments, the location of the first shielding layer 230 is configured in response to the location of the traces 223. Therefore, the traces 223 are completely shielded by the first shielding layer 230 and the size of the first shielding layer 230 is reduced. Therefore, the touch control area 221 of the touch control panel 220 is then become larger. Since the first shielding layer 230 is coated and is configured to cover the traces 223, the first shielding layer 230 does not need to align the traces 223. There is no need to configure an additional area for the first shielding layer 230 and the size of the first shielding layer 230 then becomes smaller. Moreover the size of the substrate 210 is closely same as the size of the touch control panel 220. As shown in FIG. 2, in order to clearly present the substrate 210 and the touch control panel 220 and schematic illustration of the embodiment of the present disclosure, the size of the touch control panel 220 is slightly smaller than the size of the substrate 210.

The touch control display panel, in this embodiment, includes the first shielding layer 230 disposed on the side surface, away from the substrate 210, of the non-touch control area 222 to shield the traces 223 of the non-touch control area 222. The traces 223 are then not viewed by the users when operating the touch control display panel. Moreover, the first shielding layer 230 and the traces 223 are disposed on a side of the touch control panel 220. In this embodiment, the first shielding layer 230 is disposed in response to the traces 223 in order to ensure reducing the area of the first shielding layer 230. The first shielding layer 230 is configured to shield the traces 223.

Since the first shielding layer 230 is coated and is configured to cover the traces 223, the first shielding layer 230 does not need to align the traces 223. There is no need to configure an additional area for the first shielding layer 230. The bezel of the touch control display panel is then reduced and the touch control display panel including a smaller non-touch control area for achieving the goal of a narrow bezel design for the touch control display panel. Therefore, the technical problems of forming the narrow bezel of the touch control display panel caused by the oversize of the shielding area of the ink layer applied on a glass cover are then resolved. Furthermore, when the traces 223 are shielded by the first shielding layer 230, the first occlusion layer 230 can be directly coated on the area of the trace 223. The first shielding layer 230 does not need to be pasted, via the optical adhesive, to the touch control panel 220. The thin design of the touch control panel can be achieved, and the thin design of the touch control display panel is achieved as well.

In some embodiments, the thickness of the first shielding layer 230 is less than or equal to 35 micrometers. The touch control display panel then becomes thinner, which is a benefit to the thin design of the touch control display panel. Therefore, the first shielding layer 230 will not be easily curled. The first shielding layer 230 is then strongly adhesive on the non-touch control area 222 which will improve the life of the touch control display panel. Moreover, since the thickness of the first shielding layer 230 is smaller or equal to 35 microns, the bubbles are not easily produced during bonding processes of the touch control panel 220 and other layers and the manufacturing yield of the touch control display panel is then improved.

In some embodiments, the material of the first shielding layer 230 includes at least one of ink material, coating material or polyimide material. When the material of the first shielding layer 230 is ink material, the color of the ink is then adjustable. The color of the first shielding layer 230 is adjustable as well.

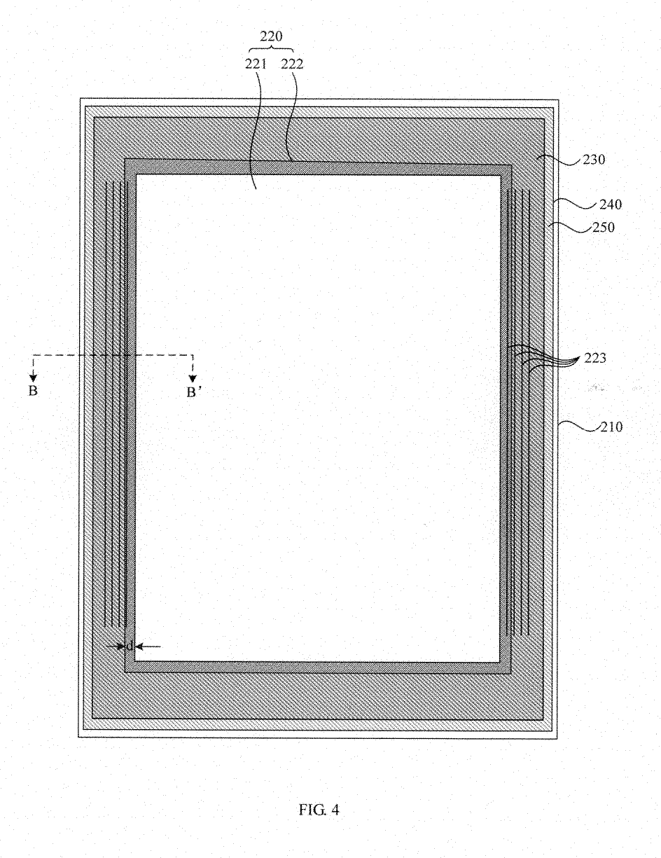

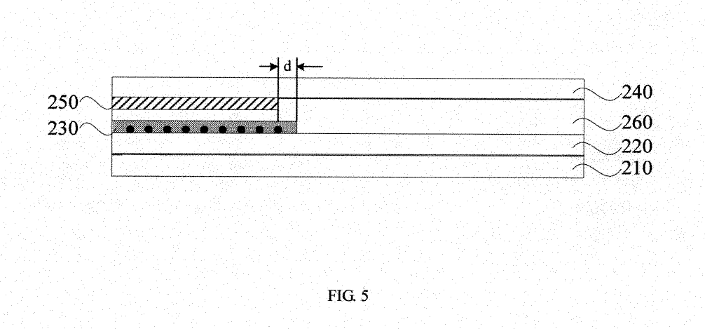

FIG. 4 shows a schematic top view of the structure of a touch control display panel of one embodiment of the present disclosure. FIG. 5 shows a cross-sectional view alone the B-B′ line of the structure of the touch control display panel of FIG. 4 of one embodiment of the present disclosure. As shown in FIGS. 4 and 5, the touch control display panel further includes a second shielding layer 250, wherein the touch control panel 220 is sandwiched between the first shielding layer 230 and the second shielding layer 250 and a protective cover 240 is disposed on the first shielding layer 230, wherein a vertical projection, projected onto the substrate 210, of the first shielding layer 230 is completely overlapped on a vertical projection, projected onto the substrate 210, of the second shielding layer 250.

In some embodiments, the second shielding layer 250 is disposed on a side, close to the touch control panel 220, of the protective cover 240. As shown in FIGS. 4 and 5, the second shielding layer 250 is disposed under the protective cover 240. The vertical projection, projected onto the substrate 210, of the first shielding layer 230 is completely overlapped on the vertical projection, projected onto the substrate 210, of the second shielding layer 250, to minimize the bezel area of the touch control display panel. Therefore, the narrow bezel design of the touch control display panel is then achieved.

Moreover, since the first shielding layer 230 is fully shielding the traces 223, in this embodiment, there is no need to consider the alignment accuracy of the second shielding layer 250 and the traces 233 even the second shielding layer 250 does not fully shielding the traces. The users will not see the traces 223 when operating the touch control display panel.

Furthermore, in the existing technology, the driving integrated circuits (IC) are usually bonded on the flexible circuit board. In order to minimize the size of the touch control display panel, the flexible circuit board is usually bended from the touch control side of the touch control panel 220 to the non-touch control side of the touch control panel 220. Thus, it is necessary to have slots (not shown) on the non-touch control area 222 of the touch control panel 220. The second shielding layer 250 is disposed on a side, close to the touch control panel 220, of the protective cover 240. Therefore, the second shielding layer 250 is shielding the slots and the users will not see the slots during operating the touch control display panel.

The touch control display panel, provided in the present disclosure, includes the second shielding layer 250 disposed on the side, close to the touch control panel 220, of the protective cover 240. The vertical projection, projected on the substrate 210, of the second occlusion layer 250 is fully covered by the projection, projected on the substrate 210, of the first shielding layer 230, which minimizes the bezel size of the touch control panel 220. Moreover, the second shielding layer 250 is configured to shield the slots area formed by the flexible circuit board bended from the touch control side of the touch control panel 220 to the non-touch control side of the touch control panel 220. Therefore, the users will not see the slots when operating the touch control display panel.

In some embodiments, the protective cover 240 includes a glass protective cover or a flexible protective cover. The protective cover 240 is configured to protect the touch control panel 220 when heavy objects falling on the touch control display panel or an electronic device including the touch control display panel dropped. In some embodiments, the material of the flexible protective cover further includes at least one of polyimide material, plexiglass material, polyterephthalic plastic material, polyurethane material. In some embodiments, the material of the flexible protective cover includes organic polymer materials.

In some embodiments, as shown in FIGS. 4 and 5, a distance “d” between the edge of the vertical projection, projected on the substrate 210, of the first shielding layer 230 and the edge of the vertical projection, projected on the substrate 210, of the second shielding layer 250 is greater than or equal to 0.15 millimeter. In this embodiment, the mentioned edges are the inner edge. The outer edge of the vertical projection, projected on the substrate 210, of the first shielding layer 230 is overlapped on the outer edge of the vertical projection, projected on the substrate 210, of the second shielding layer 250. Therefore, the vertical projection of the second shielding layer 250 is fully covered by the vertical projection of the first shielding layer 230. The bezel size of the touch control panel 220 will not be enlarged. Moreover, as shown in FIG. 4, in order to clearly present the touch control panel 220 and the protective cover 240 and schematic illustration of the embodiment of the present disclosure, the size of the protective cover 240 is slightly larger than the size of the touch control panel 220. Furthermore, in order to clearly present the first shielding layer 230 and the second shielding layer 250 and schematic illustration of the embodiment of the present disclosure, the outer edge of the second shielding layer 250 is slightly larger than the outer edge of the first shielding layer 230.

In some embodiments, the color of the first shielding layer 230 is same as the second shielding layer 250. Therefore, the users are not able to distinguish the first shielding layer 230 and the second shielding layer 250, which provides the users a good user experience. For example, since the colors of the first shielding layer 230 and the second shielding layer 250 are exactly the same, the users are not able to distinguish the first shielding layer 230 and the second shielding layer 250 by their eyes.

In some embodiments, the color of the first shielding layer 230 and the second shielding layer 250 is adjustable and is decided in response to the selected material. For example, the material of the second shielding layer 250 includes at least one of ink material, coating material or polyimide material. In some embodiments, the color of the first shielding layer 230 and the second shielding layer 250 is different, which provides varieties of color configurations. Therefore, in this embodiment, the color of the first shielding layer 230 and the second shielding layer 250 is not limited.

In some embodiments, as shown in FIG. 5, the touch control panel 220 is pasted, by an adhesive layer 260, to the protective cover 240. The adhesive layer 260, in some embodiments, includes an optical transparent adhesive which allow the light of the display panel pass through. Therefore, the contents shown on the display panel is viewed by the user from a side, away from the substrate 210, of the protective cover 240.

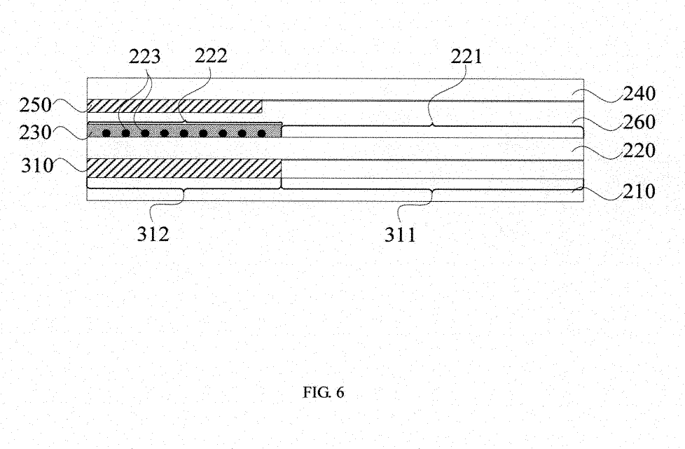

FIG. 6 shows a schematic view of the structure of a touch control display panel of one embodiment of the present disclosure. In this embodiment, the touch control display panel further includes a display panel 310 sandwiched between the substrate 210 and the touch control panel 220. The display panel 310 includes a display area 311 surrounded by a non-display area 312. A vertical projection, projected on the substrate 210, of the display area 311 overlaps with that of the touch control area 221.

In some embodiments, a vertical projection, projected on the substrate 210, of the non-display area 312 overlaps with that of the non-touch control area 222. In some embodiments, a vertical projection, projected on the substrate 210, of the display area 311 is completely overlapped on a vertical projection, projected on the silicon substrate 210, of the touch control area 221.

As shown in FIG. 6, in this embodiment, a vertical projection, projected on the substrate 210, of the display area 311 is overlapped on a vertical projection, projected on the silicon substrate 210, of the touch control area 221. Therefore, in the mentioned embodiments, the size of the display area 311 of the display panel 310 is not affected by the touch panel 220, and the goal of the narrow bezel design of the touch control display panel is achieved. Moreover, the display panel 310 includes the liquid crystal display panel 310 or the organic light emitting display panel.

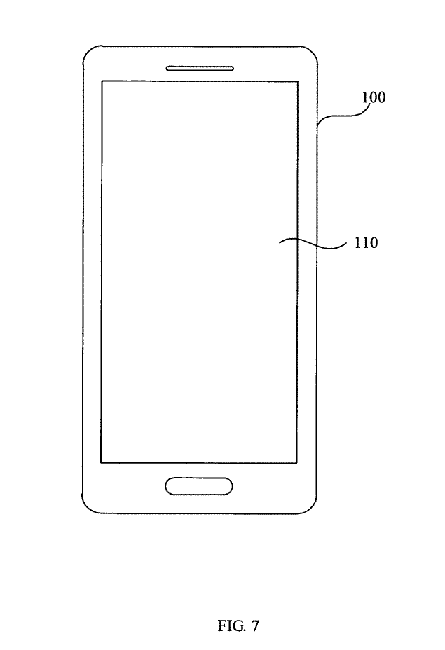

FIG. 7 shows a schematic view of the structure of a display device of one embodiment of the present disclosure. As shown in FIG. 7, a display device 100 includes the touch control display panel of the mentioned embodiments of the present disclosure. The display device, in some embodiments, includes a cell phone of FIG. 7. In some embodiments, the display device includes computers, televisions with flat display panel, and intelligence wearable display device.

What is claimed is:

1. A touch control display panel, comprising:
a substrate; and
a touch control panel disposed on a first side of the substrate;
wherein the touch panel includes a touch control area and a non-touch control area surrounding the touch control area;
wherein the non-touch control area includes a plurality of traces and a first shielding layer is disposed on a surface, away from the substrate, of the non-touch control area to shield the traces of the non-touch control area.

2. The touch control display panel of claim 1 further including a second shielding layer, wherein a protective cover is disposed on a side, away from the substrate, of the touch control panel and a second shielding layer is sandwiched between the touch control panel and the protective cover, wherein a vertical projection, projected onto the substrate, of the second shielding layer is fully covered by a vertical projection, projected onto the substrate, of the first shielding layer.

3. The touch control display panel of claim 2, wherein a distance between the edge of the vertical projection of the first shielding layer and the edge of the vertical projection of the second shielding layer is greater than or equal to 0.15 millimeter.

4. The touch control display panel of claim 2, wherein the thickness of the first shielding layer is less than or equal to 35 microns.

5. The touch control display panel of claim 2, wherein the material of the first shielding layer and the second shielding layer are selected from at least one of ink material, coating material or polyimide material.

6. The touch control display panel of claim 1, wherein a display panel disposed between the substrate and the touch control panel and the display panel includes a display area and a non-display area surrounded the display area, wherein a vertical projection, projected on the substrate, of the display area overlaps with that of the touch control area, and wherein an overlapping projection is formed by a vertical projection, projected on the substrate, of the non-display area and a vertical projection, projected on the silicon substrate, of the non-touch control area.

7. The touch control display panel of claim 2 further comprising a bonding layer disposed between the touch control panel and the protective cover, wherein the bonding layer is configured to bond the touch control panel and the protective cover.

8. The touch control display panel of claim 2, wherein the protective cover includes a glass protective cover and a flexible protective cover.

9. The touch control display panel of claim 8, wherein the flexible protective cover includes at least one of polyimide material, plexiglass material, polyterephthalic plastic material, polyurethane material.

10. A display device, comprising:
a touch control display panel further comprising:
a substrate; and
a touch control panel disposed on a first side of the substrate;
wherein the touch panel includes a touch control area and a non-touch control area surrounding the touch control area;
wherein the non-touch control area includes a plurality of traces and a first shielding layer is disposed on a surface, away from the substrate, of the non-touch control area to shield the traces of the non-touch control area.

11. The touch control display panel of claim 10 further including a second shielding layer, wherein a protective cover is disposed on a side, away from the substrate, of the touch control panel and a second shielding layer is sandwiched between the touch control panel and the protective cover, wherein a vertical projection, projected onto the substrate, of the first shielding layer is completely overlapped on a vertical projection, projected onto the substrate, of the second shielding layer.

12. The touch control display panel of claim 11, wherein a distance between the edge of the vertical projection of the first shielding layer and the edge of the vertical projection of the second shielding layer is greater than or equal to 0.15 millimeter.

13. The touch control display panel of claim 11, wherein the thickness of the first shielding layer is less than or equal to 35 millimeter.

14. The touch control display panel of claim 11, wherein the material of the first shielding layer and the second shielding layer are selected from at least one of ink material, coating material or polyimide material.

15. The touch control display panel of claim 10, wherein a display panel disposed between the substrate and the touch panel and the display panel includes a display area and a non-display area surrounded the display area, wherein a vertical projection, projected on the substrate, of the display area overlaps with that of the touch control area, and wherein an overlapping projection is formed by a vertical projection, projected on the substrate, of the non-display area and a vertical projection, projected on the silicon substrate, of the non-touch control area.

16. The touch control display panel of claim 11 further comprising a bonding layer disposed between the touch control panel and the protective cover, wherein the bonding layer is configured to bond the touch control panel and the protective cover.

17. The touch control display panel of claim 11, wherein the protective cover includes a glass protective cover and a flexible protective cover.

18. The touch control display panel of claim 17, wherein the flexible protective cover includes at least one of polyimide material, plexiglass material, polyterephthalic plastic material, polyurethane material.
